(19) United States
(12) Patent Application Publication
(10) Pub. No.: US 2013/0038866 A1
(43) Pub. Date: Feb. 14, 2013

(54) AIR FLOW MANAGEMENT IN A SYSTEM WITH HIGH SPEED SPINNING CHUCK

(71) Applicants: George J. Kren, Los Altos Hills, CA (US); Paul Doyle, San Jose, CA (US); Alexander Belyaev, Campbell, CA (US)

(72) Inventors: George J. Kren, Los Altos Hills, CA (US); Paul Doyle, San Jose, CA (US); Alexander Belyaev, Campbell, CA (US)

(73) Assignee: KLA-TENCOR CORPORATION, Milpitas, CA (US)

(21) Appl. No.: 13/565,212

(22) Filed: Aug. 2, 2012

Related U.S. Application Data
(60) Provisional application No. 61/522,569, filed on Aug. 11, 2011.

(51) Int. Cl. G01N 21/00; B23B 31/30; B23B 31/02

(52) U.S. Cl. 356/237.5; 279/142; 279/3; 279/126

(57) ABSTRACT

The present invention is directed to a high speed, spinning chuck for use in a semiconductor wafer inspection system. The chuck of the present disclosure is configured with a turbulence-reducing lip. Spinning of the chuck produces radial airflows proximal to a surface of the wafer and proximal to the bottom of the chuck. The turbulence-reducing lip of the chuck of the present disclosure directs the radial airflows off of the top surface of the wafer and the bottom surface of the chuck in a manner that minimizes the size of the low pressure zone formed between these radial airflows. The minimization of the low pressure zone reduces air turbulence about the periphery of the chuck and substrate, thereby reducing the possibility of contaminants in the system being directed onto the surface of the substrate by such air turbulence.

### CROSS-REFERENCE TO RELATED APPLICATIONS

The present application claims priority under 35 U.S.C. §119(e) to U.S. Provisional Application No. 61/522,569 entitled: Air Flow Management in a System With High Speed Spinning Chuck filed Aug. 11, 2011, which is hereby incorporated by reference in its entirety.

### FIELD OF THE INVENTION

The present invention generally relates to spinning chucks used in conjunction with inspection systems, such as semiconductor wafer inspection systems, and more particularly to a high speed spinning chuck which may allow for air flow management when used with such inspection systems.

### BACKGROUND OF THE INVENTION

As demand for ever-shrinking semiconductor devices continues to increase, so too will the demand for improved semiconductor device fabrication methodologies and semiconductor wafer inspection sensitivity. Due to the continued increase in complexity of modern integrated circuits, the tolerance for the presence of defects on a surface of a semiconductor wafer during and/or after fabrication continues to decrease. One class of defects that commonly negatively impact device fabrication and performance are contamination defects. One source of contamination defects results from the utilization of current wafer chucking systems. When spun at high rotational speeds, commonly implemented spinning wafer chucking systems, the top and bottom surfaces of the wafer/chuck assembly act as centrifugal pumps. This effect creates a layer of air on both the top and bottom surface that rapidly move from the centers (e.g., center of wafer) to the edges of the surfaces. The outward airflow, in turn, generates a low pressure zone at the centers of the top and bottom surfaces, when promotes the movement of more air into the center air from regions external to the wafer region. The air tending to flow into the low pressure zone may include various types of contaminants. The top and bottom layers of the pumped air meet generally off the chuck edge, and in a commonly implemented chuck combine at some distance away from the chuck, creating a low pressure zone between the two airflows. This low pressure zone is immediately filled with surrounding air, thereby generating a zone of air turbulence. This turbulence may bring contaminants from the downstream region (i.e., the below the chuck), which is generally not sufficiently clean. As a result of this turbulence, contaminants may be displaced from a region below the wafer and/or wafer chuck to a top surface of the wafer. The introduction of these contaminants onto the surface of a given semiconductor wafer have severe consequences on the performance of the semiconductor devices fabricated on wafer. As such, it is desirable to provide an improved rotating wafer chuck that acts to cure the turbulence, thereby reducing chuck rotation induced contamination in a semiconductor fabrication or inspection processes.

### SUMMARY OF THE INVENTION

Accordingly an embodiment of the invention is directed to a high speed, spinning chuck, including, but not limited to, a first surface, the first surface configured for supporting and retaining a substrate; and a second surface, the second surface being configured generally opposite the first surface, the second surface including at least one of: a sloped portion and a curved portion, the chuck configured for being connected to a driving mechanism, the driving mechanism configured for causing the chuck to rotate about a vertical axis, the vertical axis being perpendicular to the first surface, wherein the first surface of the chuck and the at least one of sloped portion and curved portion of the second surface of the chuck form a turbulence-reducing lip for: promoting a reduction in air turbulence proximal to the chuck when the chuck is rotating; and for promoting the reduction of a separation between a first radial airflow produced proximal to the substrate and a second radial airflow produced proximal to the second surface of the chuck when the chuck is rotating, thereby promoting reduced deposition of contaminants upon the substrate.

A further embodiment of the present disclosure is directed to a semiconductor wafer inspection system, the system including, but not limited to, a vacuum chuck, the vacuum chuck configured for supporting and retaining the semiconductor wafer, the vacuum chuck configured for being connected to a shaft and motor, the vacuum chuck configured for being rotated via the shaft and motor; an inspection tool configured to optically inspect at least a portion of the semiconductor wafer supported and retained by the vacuum chuck, the inspection tool comprising: a laser light source, the laser light source configured for producing a beam of light, the beam of light illuminating an area on the semiconductor wafer; an imaging camera, the imaging camera configured to detect light emanating from the illuminated area on the semiconductor wafer; a set of optical elements configured for imaging the area on the semiconductor wafer illuminated by the beam of light onto an imaging portion of the camera, wherein the vacuum chuck includes a first surface and a second surface, the second surface being configured generally opposite the first surface, the first surface being configured for supporting the semiconductor wafer, the second surface including at least one of: a sloped portion and a curved portion, the first surface of the chuck and the at least one of sloped portion and curved portion of the second surface of the chuck forming a turbulence-reducing lip for: promoting a reduction in air turbulence proximal to the chuck when the chuck is rotating; and for promoting the reduction of a separation between a first radial airflow produced proximal to the substrate and a second radial airflow produced proximal to the second surface of the chuck when the chuck is rotating, thereby promoting reduced deposition of contaminants within the system upon the wafer.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic diagram of a wafer chuck, in accordance with an exemplary embodiment of the present disclosure;

FIG. 2A is a schematic diagram of a wafer chuck having a generally cylindrical shape in accordance with currently available embodiments, the chuck shown supporting a substrate and being connected to a driving mechanism for rotating the chuck, in accordance with an exemplary embodiment of the present disclosure;

FIG. 2B is a schematic diagram of a wafer chuck, in accordance with an exemplary embodiment of the present disclosure;

FIG. 3 is a block diagram view of an inspection system equipped with a wafer chuck, in accordance with an embodiment of the present invention.

### DETAILED DESCRIPTION OF THE INVENTION

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention. Reference will now be made in detail to the subject matter disclosed, which is illustrated in the accompanying drawings.

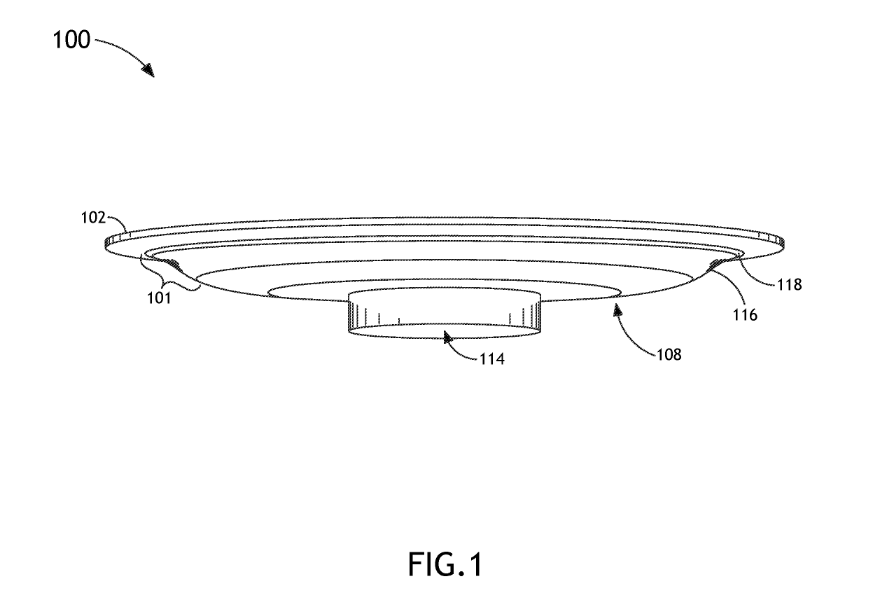

Referring generally to FIGS. 1 through 3B, a wafer chucking apparatus 100 is described in accordance with the present invention. The present invention is directed to an improved wafer chuck 100 suitable for providing reduced contamination caused by air flow patterns generated by high wafer spinning speeds within an implementing system, such as a wafer inspection system. The present invention is further directed to an inspection system 300 equipped with the wafer chuck 100 suitable for providing improved accuracy and efficiency as a result of reduced air flow induced contamination. Since generally spinning of wafers is required to carry out an inspection process, the ability to provide a low contamination environment at high chuck/wafer spinning speeds may lead to an increase in inspection throughout.

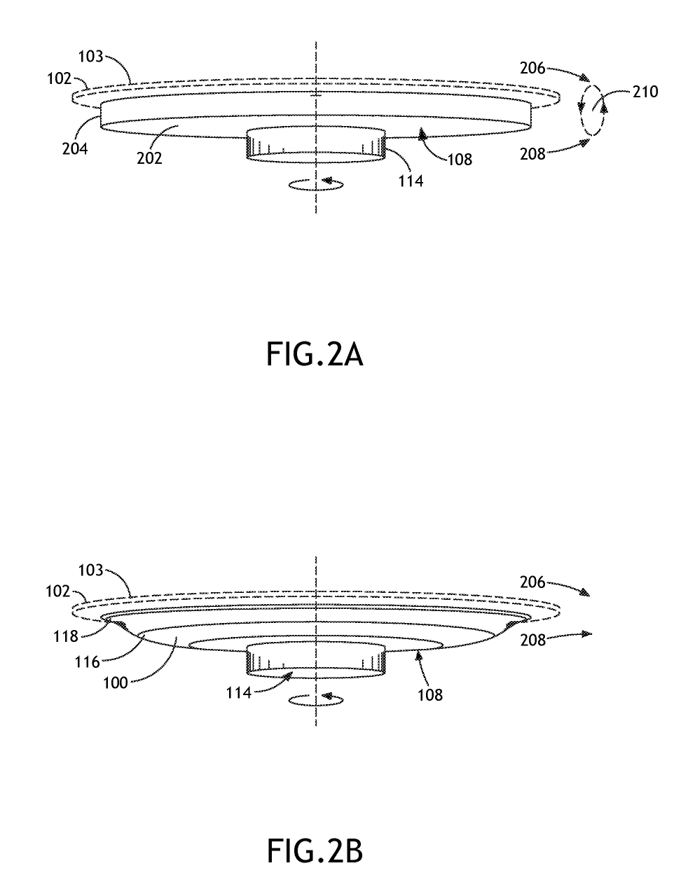

FIG. 1 illustrates a schematic view of a winged-shaped wafer chuck 100, in accordance with one embodiment of the present invention. In one aspect of the invention, the wafer chuck 100 includes an airfoil structure 101 configured to provide reduced air turbulence around the perimeter of the wafer 102 during high speed spinning of the chuck 100 and wafer 102. For example, the airfoil structure may include a winged-shaped airfoil structure suitable for reducing air turbulence about the perimeter of the wafer/chuck edges when spun at high speeds (e.g., up to 10,000 RPM), as shown in FIG. 1. The reduced air turbulence about the perimeter of the chuck 100, in turn, aides in reducing contamination of an implementing environment (e.g., inspection system) by reducing the amount of contaminants “lifted” from the region below the chuck 100 and wafer 100 to the surface 103 of the wafer 102. In a general sense, any airfoil structure capable of reducing the air turbulence about the perimeter of the wafer 102 and chuck 100 is suitable for implementation in the present invention. In one embodiment, the implemented airfoil structure 101 may include a solid machined portion (as shown in FIG. 1), which includes a sloped region 116 and lip 118 positioned between the bottom-most portion of the chuck 100 and the top-most portion of the chuck 100. In another embodiment, the implemented airfoil structure 101 may include one or more ring structures that may be attached to a currently existing chuck (e.g., chuck 202 in FIG. 2A). The attachable ring structure (not shown) may include features similar to the slope 116 and lip portions depicted in FIG. 1, thereby allowing a user to retrofit presently existing chucking systems with the contamination reducing ability of the present invention.

In another aspect of the present invention, the wafer chuck 100 consists of a vacuum-based wafer chuck configured to secure a wafer 102 (e.g., semiconductor wafer) utilizing a supplied vacuum. In one embodiment, the vacuum chuck 100 may be configured as a generally circular bowl-shaped structure and may include a top surface 104 (e.g., a support surface) configured for supporting (e.g., holding) the wafer 102 in place. In an alternative embodiment, the wafer chuck 100 may include an edge handling wafer chuck (not shown).

In another embodiment, the vacuum chuck 100 may be configured for having an air current drawn through it to create a vacuum for securing the wafer 102 to a support surface of the chuck 100. In this regard, a wafer 102 placed on top of the vacuum chuck 100 will experience a pressure difference between the external environment and the evacuated volume of the vacuum chuck (not shown), thereby securing the wafer 102 on the support surface of the chuck 100. For example, a vacuum may be applied to a bottom surface of the wafer 102 via a vacuum line (not shown) coupled to an external vacuum pump (not shown), whereby an inlet for the vacuum line is disposed on a bottom surface 108 (e.g., the surface opposite the support surface) of the chuck 100. In this regard, a vacuum system may establish a vacuum, which acts to securely draw and hold the wafer 102 against the support surface of the chuck 100.

In another embodiment, the vacuum chuck 100 may be integrally supported by a shaft 114 (e.g., spindle). For example, the shaft 114 may be connected to a motor (e.g., spindle motor) (not shown). In this regard, the spindle motor may be configured to rotate the shaft 114, thereby rotating the vacuum chuck 100 about an axis perpendicular to the support surface 104 (e.g., z-axis). For instance, the chuck 100 may be rotated at speeds greater than 1,000 revolutions per minute (rpm) (e.g., 1,000 to 10,000 rpm).

FIGS. 2A and 2B illustrate schematic views of both a commonly implemented wafer chuck 202 and the wafer chuck 100 of the present invention, respectively. Currently available vacuum chucks, such a the wafer chuck 202 illustrated in FIG. 2A, are generally cylindrically-shaped, having a top surface support surface and a bottom surface connected via a cylindrically-shaped outer wall 204, whereby the top and bottom surfaces of the chuck 202 form opposite ends of the cylinder. During a wafer inspection process of the wafer 102, in settings where the cylindrical chuck 202 and wafer 102 are spun at a high rate of speed, radial airflows 206, 208 are created proximal to the top surface 103 of the wafer 102 and proximal to the bottom surface 108 of the cylindrical chuck 202. It is recognized herein that the radial airflows 206, 208 generated at the opposing surfaces are caused by centrifugal air pumping resulting from the high spinning speed of the chuck 202. In turn, the radial airflows 206, 208 at the wafer 102 surface 103 and the bottom surface 108 of the chuck 202 generate a large, low pressure zone 210 about the perimeter of the chuck 202 between the radial airflows 206, 208. The low pressure zone 210, in turn, leads to local air turbulence around the perimeter of the cylindrical chuck 202. The air turbulence created around the perimeter of the cylindrical chuck 202 tends to cause lifting of contaminants 211 from a lower portion of an implementing system (e.g., inspection system 300) and may result in deposition of contaminants onto a surface of the wafer 102.

Referring now to FIG. 2B, the vacuum chuck 100 of the present invention addresses the above-referenced shortfalls associated with currently available chucks 202 by minimizing air turbulence around the perimeter of the high speed spinning chuck 100. The reduced air turbulence about the perimeter of the chuck 100, in turn, promotes a low contamination environment in implementing systems, such as a wafer inspection system 300. As shown in FIG. 2B, the support surface 104 of the chuck 100 may be a generally planar surface suitable for receiving the wafer 102. In alternative embodiments, the support surface 104 of the chuck 100 may include a recessed portion (e.g., concave portion). In a further aspect of the present invention, the bottom surface 108 of the chuck 100 may include (e.g., may form) a rounded or curved portion 116, such that the curved portion 116 connects to (e.g., curves or slopes vertically upward to) the top surface 104 of the chuck 100. In addition, the intersection of the sloped bottom surface 108 of the chuck 100 and the top surface 104 of the chuck 100 may form an outer structure, or lip 118 (e.g., turbulence reduction lip, radial airflow separation lip, and the like). The outer lip 118 may have a thickness ranging on the order of millimeters. For instance, the thickness of the outer lip 118 may be 1-2 mm. The winged structure 101 of the chuck 100 of the present invention allows for the more gradual combining of the radial airflows 206, 208 (as shown in FIG. 2B), which acts to promote the reduction of the low pressure zone between the radial airflows 206, 208 formed around the perimeter of the chuck 100. The reduction of the low pressure zone, in turn, results in the reduction in air turbulence in the region proximal to the perimeter of the chuck 100, thereby lessening the amount of contamination lifted from the region below the wafer 102. As a result, the wafer 100 promotes a lower level of contamination in an implementing environment, such as a region of a wafer inspection system 300.

In an alternative embodiment, an airfoil structure consisting of a wing-shaped ring (when viewing edge on) (not shown) may be selectably attached to a standard chuck 202. In this regard, a ring structure which incorporates the curvature, slop, and lip features described previously herein may be attached to a surface of a stand chuck 202, such as a cylindrical shaped chuck. It is anticipated that the advantages of the winged-structure evident in the chuck 100 of the present invention will be applicable to a wing-shaped ring attachment suitable for retrofitting currently existing vacuum-based wafer chucks 202.

In an additional alternative embodiment, airfoil structure may include a stationary airfoil structure (not shown) positioned proximate to the top surface of a standard chuck (e.g., chuck 202). The stationary airfoil structure may act to disrupt the air flow pattern, as described previously herein, thereby reducing the amount of contaminants displaced from a region below the chuck and wafer assembly to the surface of the wafer 102.

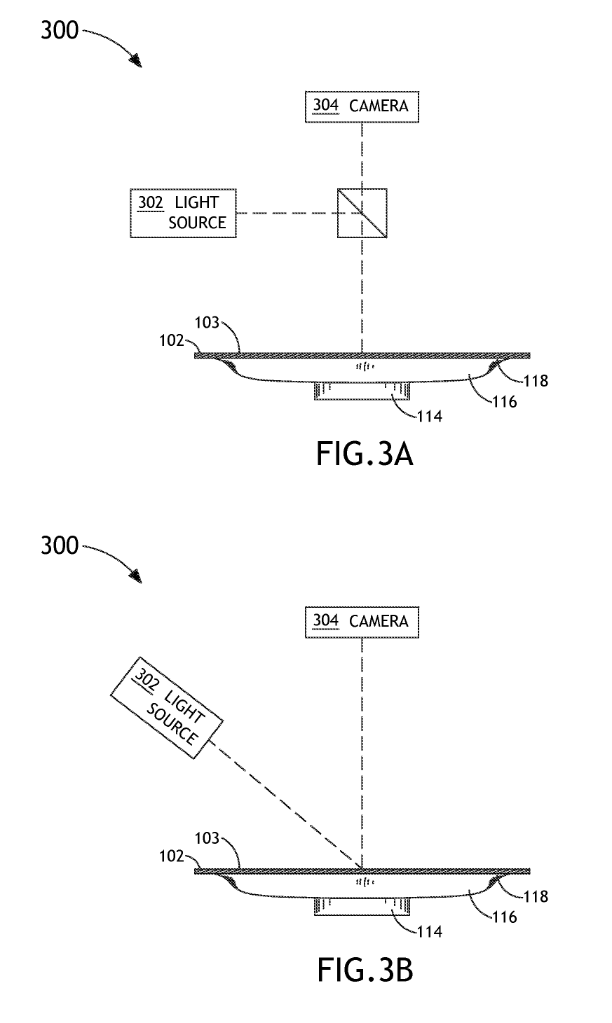

FIGS. 3A and 3B illustrate high-level block diagram views of inspection systems 300 equipped with the low contamination winged-shaped wafer chuck 100, in accordance with embodiments of the present invention. In a general sense, the wafer inspection system 300 of the present invention may include the winged-shaped wafer chuck 100 previously described herein, at least one light source 302 (e.g., a laser) configured to illuminate an area on the surface of the wafer 102, and a detector, or camera 304, such as a CCD or TDI based detector, or a photomultiplier detector, suitable for detecting light reflected or scattered from the area illuminated by the light source. In addition, the inspection system 300 may include a set of optical elements (e.g., illumination optics, collection optics, and the like) configured for directing (and focusing) illumination from the light source 302 onto the surface of the wafer 102 and, in turn, directing illumination from the surface of the wafer 102 to the imaging portion of the camera 304 of the inspection system 300. For instance, the set of optical elements may include, but is not limited to, primary imaging lens suitable for imaging the illuminated area on the semiconductor wafer onto a collection region of the camera. Further, the imaging camera 304 may be communicatively coupled to an image processing computer which may identify and store imagery data acquired from the camera 304.

The inspection system 300 of the present invention may be configured as any inspection system known in the art. For example, as shown in FIG. 3A, the inspection system 300 of the present invention may be configured as a bright field (BF) inspection system. Alternatively, as shown in FIG. 3B, the inspection system 300 may be configured as a dark field (DF) inspection system. Applicant notes that the optical configurations depicted in FIGS. 3A and 3B are provided merely for illustrative purposes and should not be interpreted as limiting. In a general sense, the inspection system 300 of the present invention may include any set of imaging and optical elements suitable for imaging the surface of the wafer 102. Examples of currently available wafer inspection tools are described in detail in U.S. Pat. No. 7,092,082, U.S. Pat. No. 6,702,302, U.S. Pat. No. 6,621,570 and U.S. Pat. No. 5,805,278, which are each herein incorporated by reference.

In a further aspect of the present disclosure, the vacuum chuck 100, wafer 102, light source 302, imaging camera 304 and various optical elements of the inspection system 300 may be contained within a pressurized enclosure (e.g., an inspection chamber) (not shown) of the system 300. The inspection chamber may be maintained, by vacuum pump(s), at a vacuum pressure level suitable for processing of the wafer 102.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A chuck, comprising:
a first surface, the first surface configured for supporting and retaining a substrate; and
a second surface, the second surface being configured generally opposite the first surface, the second surface including at least one of: a sloped portion and a curved portion, the chuck configured for being connected to a driving mechanism, the driving mechanism configured for causing the chuck to rotate about a vertical axis, the vertical axis being perpendicular to the first surface,
wherein the first surface of the chuck and the at least one of sloped portion and curved portion of the second surface of the chuck form a turbulence-reducing lip for: promoting a reduction in air turbulence proximal to the chuck when the chuck is rotating; and for promoting the reduction of a separation between a first radial airflow produced proximal to the substrate and a second radial airflow produced proximal to the second surface of the chuck when the chuck is rotating, thereby promoting reduced deposition of contaminants upon the substrate.

2. A chuck as claimed in claim 1, wherein the axis is a vertical central axis of the chuck.

3. A chuck as claimed in claim 1, wherein the substrate is a semiconductor wafer.

4. A chuck as claimed in claim 1, wherein the chuck is a vacuum chuck.

5. A chuck as claimed in claim 1, wherein the chuck is an edge handling chuck

6. A chuck as claimed in claim 1, wherein the driving mechanism includes a shaft connected to a motor.

7. A chuck as claimed in claim 1, wherein the turbulence-reducing lip has a thickness ranging from one to two millimeters.

8. A chuck as claimed in claim 1, wherein the chuck is rotated at a speed ranging from 1,000 to 10,000 revolutions per minute about the vertical central axis of the chuck.

9. An inspection system for inspecting a substrate, the system comprising:
a chuck, the chuck configured for supporting and retaining the substrate, the chuck configured for being connected to a driving mechanism for rotating the chuck;
a light source, the light source configured for producing a beam of light, the beam of light illuminating an area of the substrate;
an imaging camera, the imaging camera configured to detect light emanating from the illuminated area on the substrate;
a set of optical elements, the set of optical elements including a set of illumination optics configured to focus light from the light source onto the area of the substrate, the set of optical elements further including a set of collection optics configured to collect light emanating from the area of the substrate and image the area of the substrate onto a detector portion of the imaging camera,
wherein the chuck includes a first surface and a second surface, the second surface being configured generally opposite the first surface, the first surface being configured for supporting the substrate, the second surface including at least one of a sloped portion and a curved portion, the first surface of the chuck and the at least one of sloped portion and curved portion of the second surface of the chuck forming a turbulence-reducing lip for: promoting a reduction in air turbulence proximal to the chuck when the chuck is rotating; and for promoting the reduction of a separation between a first radial airflow produced proximal to the substrate and a second radial airflow produced proximal to the second surface of the chuck when the chuck is rotating, thereby promoting reduction in deposition of contaminants within the system upon the substrate.

10. A system as claim in claim 9, wherein the inspection tool comprises at least one of a bright field (BF) inspection tool and a dark field (DF) inspection tool.

11. A system as claimed in claim 9, wherein the chuck comprises:
a vacuum chuck.

12. A system as claimed in claim 9, wherein the light source comprises:
a laser light source.

13. A system as claimed in claim 9, wherein the turbulence-reducing lip has a thickness ranging from 0.1 to ten millimeters.

14. A system as claimed in claim 9, wherein the substrate is a semiconductor wafer.

15. A system as claimed in claim 9, wherein the chuck is connected to a spindle.

16. A system as claimed in claim 15, wherein the spindle is connected to a motor, the motor being configured for driving the spindle and rotating the chuck.

17. A system as claimed in claim 16, wherein the chuck is rotated at a speed ranging from 1000 to 2000 revolutions per minute.

18. A system for inspecting a semiconductor wafer, the system comprising:
a vacuum chuck, the vacuum chuck configured for supporting and retaining the semiconductor wafer, the vacuum chuck configured for being connected to a shaft and motor, the vacuum chuck configured for being rotated via the shaft and motor;
a laser light source, the laser light source configured for producing a beam of light, the beam of light illuminating an area on the semiconductor wafer;
an imaging camera, the imaging camera configured to detect light emanating from the illuminated area on the semiconductor wafer;
a set of optical elements, the set of optical elements including a set of illumination optics configured to focus light from the light source onto the area of the semiconductor wafer, the set of optical elements further including a set of collection optics configured to collect light emanating from the area of the semiconductor wafer and image the area of the semiconductor wafer onto a detector portion of the imaging camera,
wherein the vacuum chuck includes a first surface and a second surface, the second surface being configured generally opposite the first surface, the first surface being configured for supporting the semiconductor wafer, the second surface including at least one of: a sloped portion and a curved portion, the first surface of the chuck and the at least one of sloped portion and curved portion of the second surface of the chuck forming a turbulence-reducing lip for: promoting a reduction in air turbulence proximal to the chuck when the chuck is rotating; and for promoting the reduction of a separation between a first radial airflow produced proximal to the substrate and a second radial airflow produced proximal to the second surface of the chuck when the chuck is rotating, thereby promoting reduced deposition of contaminants within the system upon the wafer.

19. A system as claim in claim 18, wherein the inspection tool comprises at least one of a bright field (BF) inspection tool and a dark field (DF) inspection tool.

20. A system as claimed in claim 18, wherein the turbulence-reducing lip has a thickness ranging from one to two millimeters.

21. A system as claimed in claim 18, wherein the chuck is rotated at a speed ranging from 1400 to 1600 revolutions per minute about a central axis of the chuck, the central axis being perpendicular to the first surface.
